(19) United States
(12) Patent Application Publication
(10) Pub. No.: US 2010/0048420 A1
(43) Pub. Date: Feb. 25, 2010

(54) Biochip and Method for Forming the Same

(75) Inventors: Yaw-Jen Chang, Tao-Yuan (TW); Cheng-Hao Chang, Tao-Yuan (TW); Chih-Yu Hu, Tao-Yuan (TW)

Correspondence Address: WPAT, PC;INTELLECTUAL PROPERTY ATTORNEYS, 7225 BEVERLY ST., ANNANDALE, VA, 22003, US

(73) Assignee: CHUNG YUAN CHRISTIAN UNIVERSITY, Tao-Yuan (TW)

(21) Appl. No.: 12/196,396

(22) Filed: Aug. 22, 2008

(51) Int. Cl. C40B 40/00; C40B 50/10

(52) U.S. Cl. 506/13; 506/28

(57) ABSTRACT

The present invention discloses a biochip and the forming method thereof. The disclosed biochip comprises a substrate and a divalent metal compound layer on the substrate. The method for forming a biochip comprises two major steps. The first step is providing a substrate, and the second step is forming a divalent metal compound layer on the substrate.

### BACKGROUND OF THE INVENTION

1. Field of the Invention

The present invention is generally related to a biochip and a method for forming the same.

2. Description of the Prior Art

At present, the biochip detection technology becomes increasingly important in biotechnology. The biochip detection technology can simultaneously detect various pathogens on a single chip and break the detection limitation achieved by traditional technologies. A microarrayed biochip is generally prepared by aligning a large quantity of bio-probes (DNA's or proteins) on a chip substrate and is used for analyzing or testing samples by the hybridization of DNA-DNA or specific binding between proteins. According to the detection objectives, there are two major categories for microarrayed biochips: DNA chip and protein chip. DNA chips use nucleotide molecules as the probes to detect their nucleotide fragments. DNA chips can also be categorized into complimentary DNA (cDNA) chips and oligonucleotide chips, according to the length of the probes spotted on chips. cDNA chips are often used in the research of gene expressions; while oligonucleotide chips can also be used in diagnosis of pathogen and genotyping, in addition to gene expression analysis.

For DNA chips, probes are immobilized on substrates and used to detect specific DNA fragments by the characteristic hybridization with complimentary DNA's. DNA chips can be applied on disease detection and shorten the time for developing new medicines. DNA chip is also a powerful tool for analyzing DNA's by appropriate dye labeling in visible emission lights. By different emission wavelengths, individual target DNA can be distinguished and analyzed.

Based on the immunological reactions between antibody and antigen, the protein on the protein chip binds to the target protein at a specific amino acid with the specificity of binding between the antibody and antigen. The binding is detected with fluorescence of the labeling marker. The research includes drug reaction, allergic reaction, function of disease messages and immunological reactions, and the influence and function of protein to the human physiologically system.

Both DNA chip and protein chip can only analyze a few samples each time. Thus, a novel biochip preparation method is needed to meet the requirement of high-volume test for commercial use.

### SUMMARY OF THE INVENTION

In accordance with the present invention, a biochip and a method for forming the same are provided.

One of the objective of the invention is to disclose an immunoassay technique. Using physics absorption between divalent metal compound layer and specific moiety of histidine, the object can be attached to the chip surface with directional array and provide high sensitivity and selectively for testing. Afterward it can be further applied to mass parallel analysis systems and a low cost and disposable immunoassay biochip.

The other objective of the present invention is to disclose a biochip which omits the blocking reaction for achieving high sensitivity, high selectively, short detection time and a small amount of test agent requirement and obtain integral experimental data.

According to the above objectives, the present invention discloses a biochip. The disclosed biochip comprises a substrate and a divalent metal compound layer on the substrate. The method for forming a biochip comprises two major steps. The first step is providing a substrate, and the second step is forming a divalent metal compound layer on the substrate.

### BRIEF DESCRIPTION OF THE DRAWINGS

FIG. 1 is a schematic diagram of the biochip according to the first embodiment of the present invention;

FIG. 2 is a schematic diagram showing the flowchart for fabricating the biochip according to the present invention;

FIG. 3 is a schematic diagram showing the flowchart for fabricating the biochip according to the present invention;

FIG. 4 is a schematic diagram showing the flowchart for fabricating the biochip according to the present invention;

FIG. 5 is a schematic diagram showing the flowchart for fabricating the biochip according to the present invention; and

FIG. 6 shows fluorescence images of the biochip from high concentration to low concentration according to the present invention.

### DESCRIPTION OF THE PREFERRED EMBODIMENTS

What is probed into the invention is a biochip and a method for forming the same. Detail descriptions of the structure and elements will be provided as followed in order to make the invention thoroughly understood. The application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail as followed. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

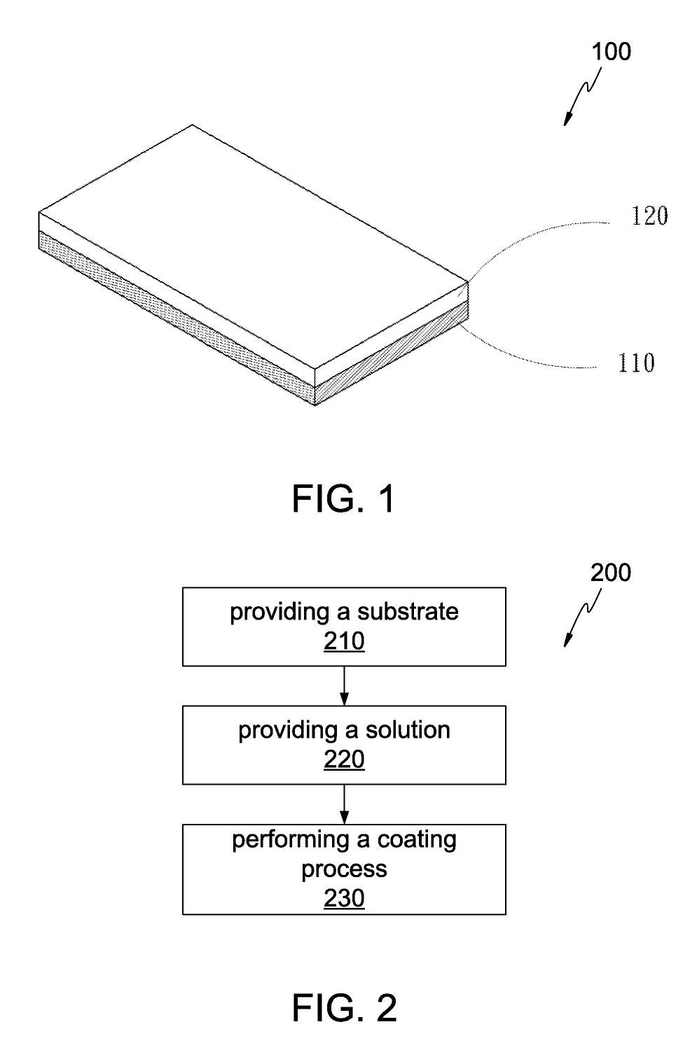

As shown in FIG. 1, a first embodiment of the present invention discloses a biochip 100, wherein the biochip comprises a substrate 110 and a divalent metal compound layer 120 on the substrate 110. The substrate 110 is an insulating substrate which can be a glass substrate, inorganic substrate or a polymer substrate, or non-insulating substrate such as metal. The divalent metal compound layer is used to binding organic molecules with at least one histidine in the structure and the better one has six histidines in the structure. The divalent metal compound of the divalent metal compound layer is selected one of the following or any combination of the following: CoSO₄.7H₂O, CoSO₄, NiSO₄, NiSO₄.6H₂O, NiSO₄.7H₂O, Ni(NH₂SO₃)₂.4H₂O, Co(NH₂SO₃)₂.4H₂O, (NH₄)₂Ni(SO₄)₂.6H₂O, NiO, Ni(OH)₂, Ni(NO₃)₂, Ni(CO₃).2Ni(OH₂).4H₂O, NiF₂.4H₂O, Ni(CN)₂.H₂O, CuSO₄, Cu₂SO₄, CuCl₂, Cu₂O, CuF₂, CuBr₂, Cu(CN), Cu(CN)₂, (NH₄)₂Co(SO₄), CoCl₂, CoCO₃, 2CoCO₃.3Co(OH)₂, CoO, NaxCo₂O₄, Co(OH)₂, Co(CN)₂.2H₂O, CoF₂, ZnCl₂, ZnCO₃, ZnO, ZnSO₄.7H₂O, ZnSO₃.2H₂O, Zn(CN)₂, and ZnF₂. Conventional biochip requires accurate and complex manufacturing processes and non-specific adsorption is apparent. Thus, the conventional biochip needs a blocking reaction to reduce the non-specific adsorption. The biochip is a biochip which omits blocking reaction, and it not only has high-sensitivity and high-selectivity but also need only a small amount of test agent and can obtains integral experimental data at once.

As shown in FIG. 2, the present invention discloses a flowchart 200 for fabricating the biochip. At first, a process 210 provides a substrate. Next, a process 220 provides a solution comprising a divalent metal compound and a silane compound. Finally, a process 230 coats the solution on the substrate to form a divalent metal compound layer. In the flowchart further comprises drying the divalent metal compound layer. The substrate is an insulating substrate such as glass substrate or inorganic substrate, or a non-insulating substrate such as metal. The divalent metal compound layer is a combination of divalent metal compound and silane compound. The divalent metal compound of said divalent metal compound layer is selected one of the following or any combination of the following: CoSO₄.7H₂O, CoSO₄, NiSO₄, NiSO₄.6H₂O, NiSO₄.7H₂O, Ni(NH₂SO₃)₂.4H₂O, Co(NH₂SO₃)₂.4H₂O, (NH₄)₂Ni(SO₄)₂.6H₂O, NiO, Ni(OH)₂, Ni(NO₃)₂, Ni(CO₃).2Ni(OH₂).4H₂O, NiF₂.4H₂O, Ni(CN)₂.H₂O, CuSO₄, Cu₂SO₄, CuCl₂, Cu₂O, CuF₂, CuBr₂, Cu(CN), Cu(CN)₂, (NH₄)₂Co(SO₄), CoCl₂, CoCO₃, 2CoCO₃.3Co(OH)₂, CoO, NaxCo₂O₄, Co(OH)₂, Co(CN)2.2H₂O, CoF₂, ZnCl₂, ZnCO₃, ZnO, ZnSO₄.7H₂O, ZnSO₃.2H₂O, Zn(CN)₂, and ZnF₂. The divalent metal compound layer can be put on the substrate using spin coating. The invention discloses the biochip which omits blocking reaction.

The silane compound is selected at least one of the following: Silane (SinH₂ₙ₊₂; n is from 1 to 15), silicon alkoxide, polysilane, silanol, Tetraalkoxy Silane, Trimethyl Silane, Vinyltrichlorosilane, Trichlorosilane, Dimethyldichlorosilane, Methyldichlorosilane, Diethyldichlorosilane, Allyltrichlorosilane (Stabilized), Dichlorosilane, ethyl silicane, dimethyldichlorosilane, silicoheptane, trimethylsilyl azide, trimethylchlorosilane, 3-mercaptopropyl trimethoxy silane, methyltrimethoxysilane, methyl silicane, tetraethyl orthosilane, tetramethoxysilane, silane coupling agent, silicobromoform, silicoiodoform, phenyltrimethoxysilane, alkylsilanediol, chloromethyl phenyltrimethoxy silane, hydroxyorganosilane, polyalkoxysilane, cyclopentasilane, and Dimethyldichlorosilane.

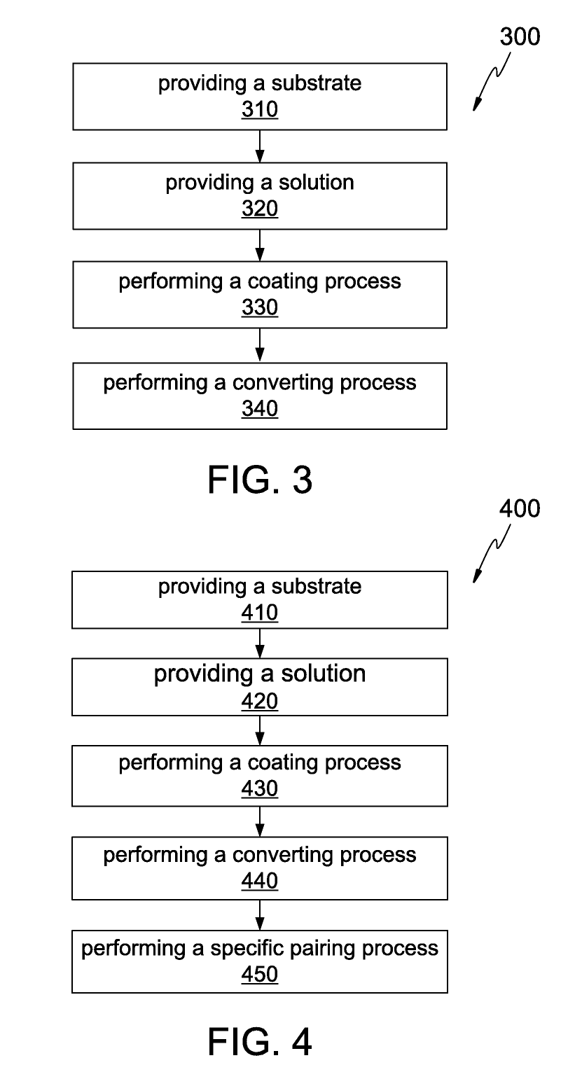

As shown in FIG. 3, the present invention discloses a flowchart 300 for fabricating the biochip. At first, a process 310 provides a substrate. Next, a process 320 provides a solution comprising a divalent metal compound and a silane compound. Next, a process 330 coats the solution on the substrate to form a divalent metal compound layer. Finally, a process 340 is a converting process. The converting process 340 comprises two steps. One step is to provide a converter which comprises a first moiety and at least one second moiety, and the other step is to bond the first moiety of the converter with the divalent metal compound layer to from a biochip having the second moiety on its surface. The first moiety comprises at least one histidine in the structure, and the better one has six histidines in the structure. The converter comprises one of following groups: antigen, monoclonal antibodies, primary antibody, polyclonal antibodies, nucleic acids comprising monomeric and oligomeric types, proteins, enzymes, lipid, polysaccharides, sugars, peptides, polypeptides, drugs, virus, microbes, and bioligands.

As shown in FIG. 4, the present invention discloses a flowchart 400 for fabricating the biochip. At first, a process 410 provides a substrate. Next, a process 420 provides a solution comprising a divalent metal compound and a silane compound. Next, a process 430 coats the solution on the substrate to form a divalent metal compound layer. Then, a process 440 is a converting process. Finally, a specific pairing process 450 comprises two steps. One step is to provide a pair, which comprises a third moiety and a fourth moiety; and the other step is to bond the second moiety of the biochip with the third moiety of the pair to form a biochip having the fourth moiety on its surface. The pair comprises one of the following: antigen, monoclonal antibodies, primary antibody, polyclonal antibodies, nucleic acids comprising monomeric and oligomeric types, proteins, enzymes, lipid, polysaccharides, sugars, peptides, polypeptides, drugs, virus, microbes, and bioligands. The converting process 440 is as the same as the converting process 340.

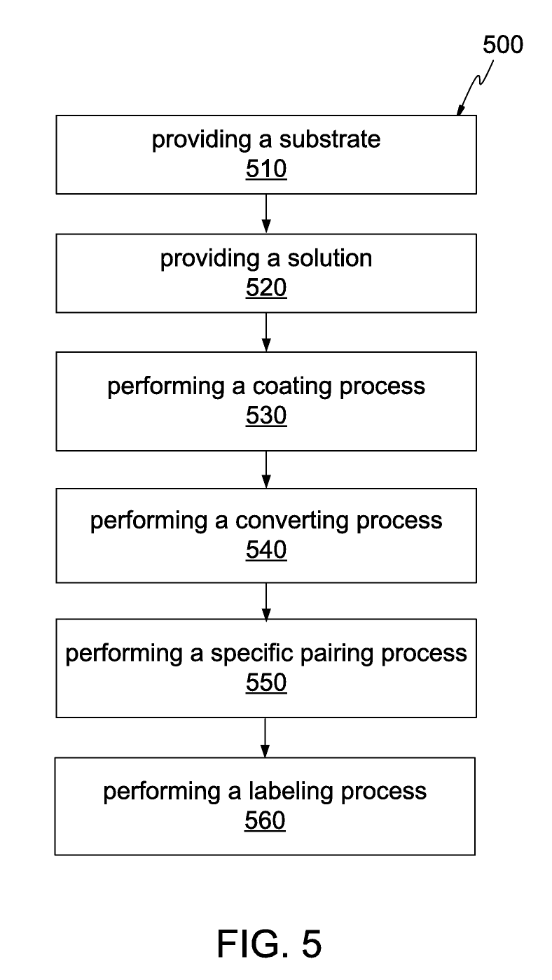

As shown in FIG. 5, the present invention discloses a flowchart 500 for fabricating the biochip. At first, a process 510 provides a substrate. Next, a process 520 provides a solution comprising a divalent metal compound and a silane compound. Next, a process 530 coats the solution on the substrate to form a divalent metal compound layer. Next, a process 540 is a converting process. Then, a process 550 is specific pairing process. Finally, a process 560 provides a labeling process. The labeling process comprises two steps. One step provides a labeling carrier that comprises at least a fifth moiety and a sixth moiety wherein the sixth moiety conjugated with a marker; and the other step is to bond the fourth moiety of the pair labeling carrier with the fifth moiety of the labeling carrier to form a biochip having the marker on its surface. The marker is one of the following group or any combination of following: fluorescence substance, phosphorescence substance, luminescence substance, enzyme, radioactive element, quantum dot, and nano diamond. The labeling carrier is selected from the group consisting of the following: antigen, monoclonal antibodies, secondary antibodies, polyclonal antibodies, nucleic acids comprising monomeric and oligomeric types, proteins, enzymes, lipids, polysaccharides, sugars, peptides, polypeptides, drugs, viruses, microbes, and bioligands. In addition, the converting process 540 is as same as the converting process 340 and the converting process 440.

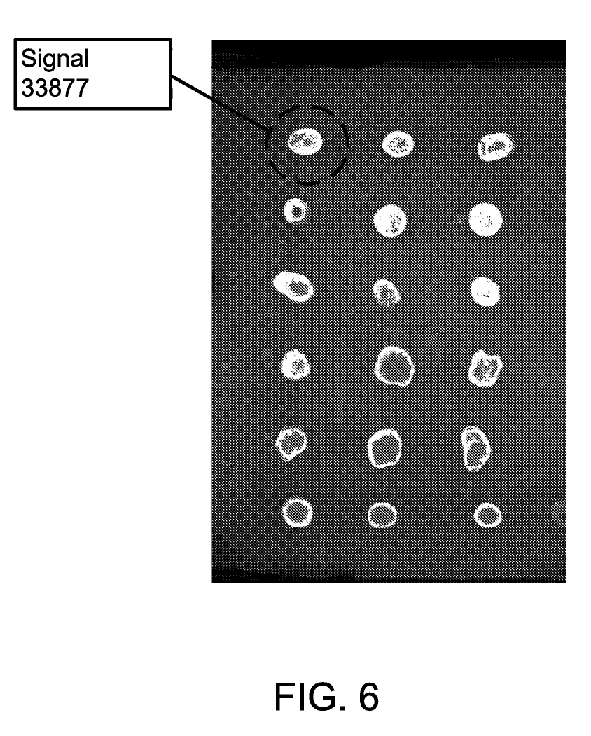

As shown in FIG. 6, CoSO₄ biochip shows fluorescence images from high concentration to low concentration, and the signal value is 33877.

### EXAMPLE

According to the present invention, the method for forming a biochip is provided. The method comprises the following steps.

(1) Methanol is as basic solution put in a lightproof test tube covered with aluminum foil.

(2) Add 3-glycidoxypropyl-(trimethoxy)silane or sigmacoate.

(3) Mix the solution in reciprocating agitating device for 8 hours.

(4) Add divalent metal compound solution (CoSO₄.7H₂O, CoSO₄, NiSO₄, NiSO₄.6H₂O, NiSO₄.7H₂O, Ni(NH₂SO₃)₂.4H₂O, Co(NH₂SO₃)₂.4H₂O)

(5) Spin-coating on a 1″×3″ glass wafer at 2000 rpm.

(6) Baking the sample in the oven at constant temperature of 60° C. for an hour.

### Immunological Reaction

6xHis-Uricase proteins are arrayed on a surface of a wafer and bake it at temperature of 37° C. for 2 hours. Coat the square array of the wafer with a low concentration Anti-Uricase, and bakes the wafer in the constant temperature oven at temperature of 37° C. for an hour. Wash the wafer with wash buffer for three minutes each time, and then shake it using a shaker at 100 rpm for three times. Rinse it in deionized water and blow nitrogen gas to dry it. Coat the square array of the wafer with a low concentration Anti-Uricase, and bake the wafer in the constant-temperature oven at temperature of 37° C. for an hour for fixing the Anti-Uricase. Wash the wafer with wash buffer for three minutes each time, then shake it using the shaker at 100 rpm for three times. Rinse it in deionized water and blow nitrogen gas to dry it.

Other modifications and variations are possibly developed in light of the above demonstrations. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A biochip, comprising:
a substrate; and
a divalent metal compound layer on said substrate.

2. The biochip according to claim 1, wherein said substrate is an insulating substrate or a non-insulating substrate.

3. The biochip according to claim 1, wherein said substrate is selected one of the following: an inorganic substrate, a polymer substrate and a metal substrate.

4. The biochip according to claim 1, wherein said divalent metal compound layer is used to binding organic molecules with at least one histidine in the structure.

5. The biochip according to claim 1, wherein said divalent metal compound layer is used to binding organic molecules with at least six histidine in the structure.

6. The biochip according to claim 1, wherein said biochip omits blocking reaction.

7. The biochip according to claim 1, wherein the divalent metal compound of said divalent metal compound layer is selected one of the following or any combination of the following: CoSO₄.7H₂O, CoSO₄, NiSO₄, NiSO₄.6H₂O, NiSO₄.7H₂O, Ni(NH₂SO₃)₂.4H₂O, Co(NH₂SO₃)₂.4H₂O, (NH₄)₂Ni(SO₄)₂.6H₂O, NiO, Ni(OH)₂, Ni(NO₃)₂, Ni(CO₃).2Ni(OH₂).4H₂O, NiF₂.4H₂O, Ni(CN)₂.H₂O, CuSO₄, Cu₂SO₄, CuCl₂, Cu₂O, CuF₂, CuBr₂, Cu(CN), Cu(CN)₂, (NH₄)₂Co(SO₄), CoCl₂, CoCO₃, 2CoCO₃.3Co(OH)₂, CoO, NaxCo₂O₄, Co(OH)₂, Co(CN)₂.2H₂O, CoF₂, ZnCl₂, ZnCO₃, ZnO, ZnSO₄.7H₂O, ZnSO₃.2H₂O, Zn(CN)₂, and ZnF₂.

8. A method for forming a biochip, comprising:
providing a substrate; and
providing a solution comprising a divalent metal compound and a silane compound;
coating said solution on said substrate to form a divalent metal compound layer.

9. The method according to claim 8, wherein said substrate is an insulating substrate or a non-insulating substrate.

10. The method according to claim 8, wherein said substrate is selected one of the following: an inorganic substrate, a polymer substrate and a metal substrate.

11. The method according to claim 8, wherein said silane compound is selected at one of the following or any combination of the following: Silane (SinH₂ₙ₊₂; n is from 1 to 15), silicon alkoxide, polysilane, silanol, Tetraalkoxy Silane, Trimethyl Silane, Vinyltrichlorosilane, Trichlorosilane, Dimethyldichlorosilane, Methyldichlorosilane, Diethyldichlorosilane, Allyltrichlorosilane (Stabilized), Dichlorosilane, ethyl silicane, dimethyldichlorosilane, silicoheptane, trimethylsilyl azide, trimethylchlorosilane, 3-mercaptopropyl trimethoxy silane, methyltrimethoxysilane, methyl silicane, tetraethyl orthosilane, tetramethoxysilane, silane coupling agent, silicobromoform, silicoiodoform, phenyltrimethoxysilane, alkylsilanediol, chloromethyl phenyltrimethoxy silane, hydroxyorganosilane, polyalkoxysilane, cyclopentasilane, and Dimethyldichlorosilane.

12. The method according to claim 8, further comprising drying said divalent metal compound layer.

13. The method according to claim 8, wherein the divalent metal compound of said divalent metal compound layer is selected one of the following or any combination of the following: CoSO₄.7H₂O, CoSO₄, NiSO₄, NiSO₄.6H₂O, NiSO₄.7H₂O, Ni(NH₂SO₃)₂.4H₂O, Co(NH₂SO₃)₂.4H₂O, (NH₄)₂Ni(SO₄)₂.6H₂O, NiO, Ni(OH)₂, Ni(NO₃)₂, Ni(CO₃).2Ni(OH₂).4H₂O, NiF₂.4H₂O, Ni(CN)₂.H₂O, CuSO₄, Cu₂SO₄, CuCl₂, Cu₂O, CuF₂, CuBr₂, Cu(CN), Cu(CN)₂, (NH₄)₂Co(SO₄), CoCl₂, CoCO₃, 2CoCO₃.3Co(OH)₂, CoO, NaxCo₂O₄, Co(OH)₂, Co(CN)2.2H₂O, CoF₂, ZnCl₂, ZnCO₃, ZnO, ZnSO₄.7H₂O, ZnSO₃.2H₂O, Zn(CN)₂, and ZnF₂.

14. The method according to claim 8, wherein said biochip omits blocking reaction.

15. The method according to claim 8, further comprising a converting process after said coating process, and said converting process comprises:
providing a converter that comprises a first moiety and at least one second moiety; and
bonding said first moiety of said converter with said divalent metal compound layer to from a biochip having said second moiety on its surface.

16. The method according to claim 15, wherein said first moiety comprises at least one histidine in the structure.

17. The method according to claim 15, wherein said first moiety comprises at least six histidines in the structure.

18. The method according to claim 15, wherein said converter is selected one group of following: antigen, monoclonal antibodies, primary antibody, polyclonal antibodies, nucleic acids comprising monomeric and oligomeric types, proteins, enzymes, lipid, polysaccharides, sugars, peptides, polypeptides, drugs, virus, microbes, and bioligands.

19. The method according to claim 15, wherein the method further comprises a specific pairing process after the converting process, and the specific pairing process comprises:
providing a pair that comprises a third moiety and a fourth moiety; and
bonding said second moiety of the biochip with said third moiety of said pair to form a biochip having said fourth moiety on its surface.

20. The method according to claim 19, wherein said pair comprises one of the following: antigen, monoclonal antibodies, primary antibody, polyclonal antibodies, nucleic acids comprising monomeric and oligomeric types, proteins, enzymes, lipid, polysaccharides, sugars, peptides, polypeptides, drugs, virus, microbes, and bioligands.

21. The method according to claim 20, further comprising a labeling process after said specific pairing process, and said labeling process comprises:
providing a labeling carrier that comprises a fifth moiety and a sixth moiety wherein conjugated with a marker; and
bonding said fourth moiety of the pair labeling carrier with at least fifth moiety of the labeling carrier to form a biochip having the marker on its surface.

22. The method according to claim 21, wherein said marker is selected from the group consisting of the following: fluorescence substance, phosphorescence substance, luminescence substance, enzyme, radioactive element, quantum dot, and nano diamond.

23. The method according to claim 21, wherein said labeling carrier is selected from the group consisting of the following: antigen, monoclonal antibodies, secondary antibodies, polyclonal antibodies, nucleic acids comprising monomeric and oligomeric types, proteins, enzymes, lipids, polysaccharides, sugars, peptides, polypeptides, drugs, viruses, microbes, and bioligands.
